(19) United States
(12) Patent Application Publication
(10) Pub. No.: US 2017/0036230 A1
(43) Pub. Date: Feb. 9, 2017

(54) DEPOSITION MASK, METHOD FOR PRODUCING DEPOSITION MASK AND TOUCH PANEL

(71) Applicant: V TECHNOLOGY CO., LTD., Kanagawa (JP)

(72) Inventor: Michinobu Mizumura, Kanagawa (JP)

(21) Appl. No.: 15/331,412

(22) Filed: Oct. 21, 2016

Related U.S. Application Data
(63) Continuation of application No. PCT/JP2015/060735, filed on Apr. 6, 2015.

(30) Foreign Application Priority Data
Apr. 24, 2014 (JP) 2014-090447

(51) Int. Cl. B05B 15/04; G06F 3/041; B05D 5/00; B05D 1/32; B05D 7/00; B05D 7/24

(52) U.S. Cl. CPC B05B 15/045; B05D 7/54; B05D 7/24; B05D 5/00; B05D 1/32; G06F 3/0412; B05D 2202/00; G06F 2203/04103; G06F 2203/04112; G06F 2203/04107

(57) ABSTRACT

The present invention comprises a sheet-like shielding member 2 having openings 5 in correspondence to a thin film pattern formed on a film-deposited substrate 8; and a mesh 3 having a plurality of lattice points 6 within the openings 5, and supported on side wall 5a portions of the openings 5 of the shielding member 2, so as to provide a clearance between the mesh 3 and one surface 2b of the shielding member 2.

### CROSS-REFERENCE TO RELATED APPLICATIONS

The present application is a continuation of International Application No. PCT/JP2015/060735, filed on Apr. 6, 2015, published in Japanese, which claims priority from Japanese Patent Application No. 2014-090447, filed on Apr. 24, 2014, the disclosures of which are hereby incorporated herein by reference.

### BACKGROUND OF THE INVENTION

1. Field of the Invention

The present invention relates to a deposition mask having openings in correspondence with a thin film pattern formed on a film-deposited substrate, and more particularly, relates to a deposition mask capable of preventing deformation of openings, a method for producing a deposition mask and a touch panel.

2. Description of Related Art

The prior art deposition mask of such a type has been known in which reinforcing lines are connected to one surface of a mask portion having at least one or more openings so as to cross the above openings, and a clearance exists between the other surface of the mask portion and the above reinforcing lines (see, for example, Japanese Patent Application Laid-open Publication No. H10-330910).

This prior art deposition mask is however accompanied by a problem that when the line width of the reinforcing line is made narrow to suppress the reinforcing line from becoming the shadow of deposition, a connection area between the mask portion and each reinforcing line becomes small so that a connection strength therebetween is reduced. Accordingly, there was a possibility of when installing the deposition mask on a film-deposited substrate upon deposition in a state of the mask portion being pulled in four directions, peeling off a connection part between the mask portion and the reinforcing line and thereby deforming the openings.

Particularly when the width of a separation portion between the adjacent openings becomes narrow like a few μm to several tens of μm, the connection area between the mask portion and each reinforcing line become smaller so that the connection strength therebetween is reduced, thereby making it easier to peel off the reinforcing line. Accordingly, a problem arises that the openings become easier to deform.

### SUMMARY OF THE INVENTION

The present invention deals with the problem, and seeks to provide a deposition mask capable of preventing deformation of openings, a method for producing a deposition mask and a touch panel.

In order to achieve the above object, a deposition mask according to the present invention comprises: a sheet-like shielding member having openings in correspondence to a thin film pattern formed on a film-deposited substrate; and a mesh having a plurality of lattice points within the openings, and supported on side wall portions of the openings of the shielding member, so as to provide a clearance between the mesh and one surface of the shielding member.

Also, a method for producing a deposition mask according to the present invention comprises: plating a magnetic metal material on a metal base material to form a sheet-like shielding member having openings in correspondence to a thin film pattern formed on a film-deposited substrate, applying a liquid resin onto the shielding member and within the openings to form a film layer thinner in thickness than the shielding member; and irradiating the film layer with laser light from a contact surface side with the metal base material to form a mesh having a plurality of lattice points at least at film layer portions corresponding to the openings, after the shielding member and the film layer are peeled off integrally from the metal base material.

Further, a method for producing a touch panel according to the present invention is a method for producing a touch panel by depositing a film using the deposition mask to form a transparent electrode on a transparent substrate, the method comprising: placing the deposition mask on the transparent substrate in such a manner that one surface side of the shielding member is brought to the side of the transparent substrate; and depositing a film from the other surface side of the shielding member to form a transparent electrode at a portion on the transparent substrate located within the opening of the shielding member by a deposition material passing through each eye of the mesh.

According to the present invention, since a mesh is supported by a shielding member with side wall portions of openings, a connection area between the mesh and the shielding member is wider than that of a deposition mask according to a prior art, and even though a line width of the mesh and the width of a separation portion of the shielding member between the mutually adjacent openings become narrow, a large change does not occur in connection strength therebetween. Thus, even though a tension is applied to the shielding member in four directions, there is no possibility of the mesh being peeled off from the shielding member as in the prior art, and deformation of the openings can be prevented.

### BRIEF DESCRIPTION OF THE DRAWINGS

FIGS. 1A and 1B are schematic configuration views illustrating one embodiment of a deposition mask according to the present invention, in which FIG. 1A is a plan view, and FIG. 1B is an A-A line sectional arrow view;

FIGS. 2A to 2C are views illustrating a principal part of FIGS. 1A and 1B in an enlarged form, in which FIG. 2A is a plan view, FIG. 2B is a B-B line sectional arrow view of FIG. 2A, and FIG. 2C is a partly enlarged sectional view;

FIG. 3 is a typical view for describing the influence of the shadow of a mesh relative to deposition;

FIG. 4 is a graph illustrating one example of a numerical calculation result for determining a line width of the mesh;

FIG. 5 is a graph illustrating another example of the numerical calculation result for determining the line width of the mesh;

FIGS. 6A to 6F are sectional views describing a mask sheet forming process in a method for producing a deposition mask according to the present invention;

FIGS. 7A and 7B are sectional views describing a frame connecting process in the method for producing the deposition mask according to the present invention;

FIGS. 8A and 8B are sectional views describing a mesh forming process in the method for producing the deposition mask according to the present invention;

FIGS. 9A and 9B are plan views illustrating one example of an eye shape of a mesh; and

FIGS. 10A to 10D are sectional views describing a producing process of a touch panel, which is performed using the deposition mask according to the present invention.

### DESCRIPTION OF PREFERRED EMBODIMENTS

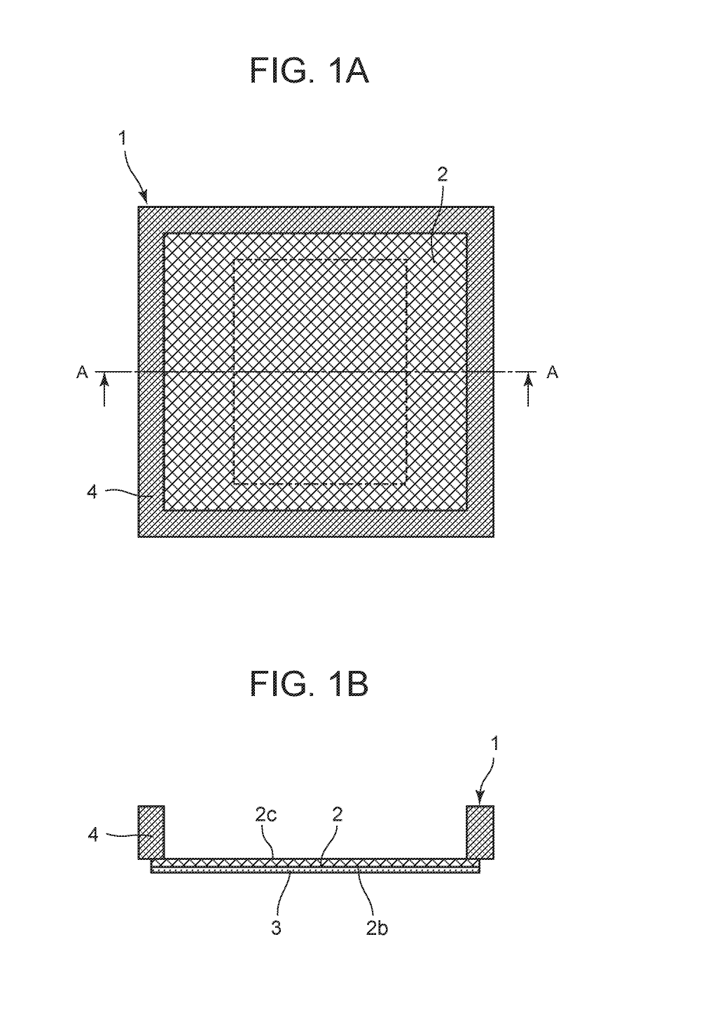

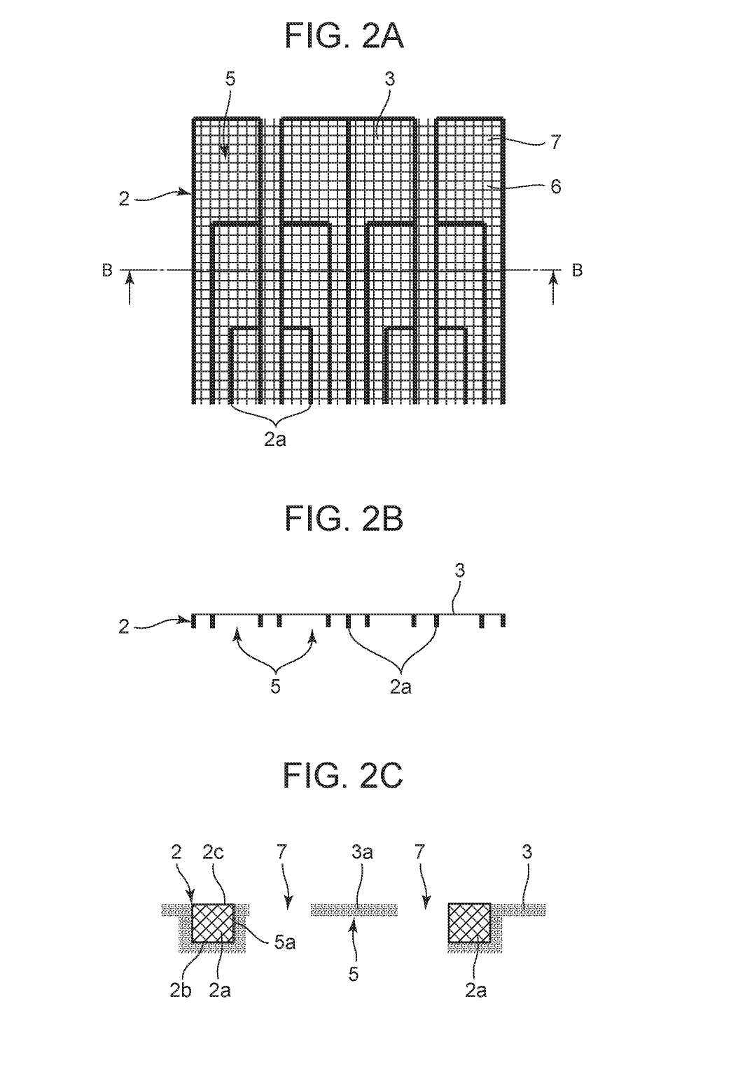

Embodiments of the present invention will hereinafter be described in detail based on the accompanying drawings. FIGS. 1A and 1B are schematic configuration views illustrating one embodiment of a deposition mask according to the present invention, in which FIG. 1A is a plan view, and FIG. 1B is an A-A line sectional arrow view. Further, FIG. 2A to 2C are views illustrating a principal part of FIG. 1A and 1B in an enlarged form, in which FIG. 2A is a plan view, FIG. 2B is a B-B line sectional arrow view of FIG. 2A, and FIG. 2C is a partly enlarged sectional view. This deposition mask 1 is one for depositing a thin film pattern on a film-deposited substrate and is configured by having a shielding member 2, a mesh 3, and a frame 4.

The above shielding member 2 is a sheet-like member having openings in correspondence to a thin film pattern formed on a film-deposited substrate (hereinafter simply called a “substrate”), and is one which is composed of a magnetic metal material such as nickel, a nickel alloy, Invar or an Invar alloy, or the like and formed by plating.

For details, as illustrated in FIG. 2A to 2C, a plurality of openings 5 irregular in shape and size are adjacently provided in the above shielding member 2. Further, a separation width between the openings 5 adjacent to each other is as narrow as a few μm to several tens of μm. Accordingly, separation portions 2a of the shielding member 2, which separate the mutually adjacent openings 5 from each other are thin line-shaped as illustrated in FIG. 2A.

A mesh 3 is provided with being held by the above shielding member 2. This mesh 3 is one for preventing deformation of each opening 5. Eyes 7 are provided so as to have a plurality of lattice points 6 within the opening 5. As illustrated in FIG. 2C, the mesh 3 is supported by the shielding member 2 such that a clearance exists between the mesh 3 and one surface 2b of the shielding member 2 within the opening 5. Thus, since the mesh 3 has the plurality of lattice points 6 within the openings 5, a constant tension is isotropically applied to the mesh 3 even when such a tension as to pull the mesh 3 in four directions is applied to the shielding member 2, thereby causing no risk of deforming each opening 5.

Here, the mesh 3 will be described in further details. As illustrated in FIG. 2C, the above mesh 3 is supported by the shielding member 2 with portions of side walls 5a of each opening 5 and a portion of one surface 2b of the shielding member 2. Thus, the connection area between the mesh 3 and the shielding member 2 is wider than that of the deposition mask of the above-mentioned prior art. Even though the line width of the mesh 3 and the width of each separation portion 2a between the mutually adjacent openings 5, of the shielding member 2 become narrow, no large change occurs in the strength of connection therebetween. Thus, even though the tension is applied to the shielding member 2 in four directions, there is no risk of the mesh 3 being peeled off from the shielding member 2 as in the prior art, and deformation of each opening 5 can be prevented.

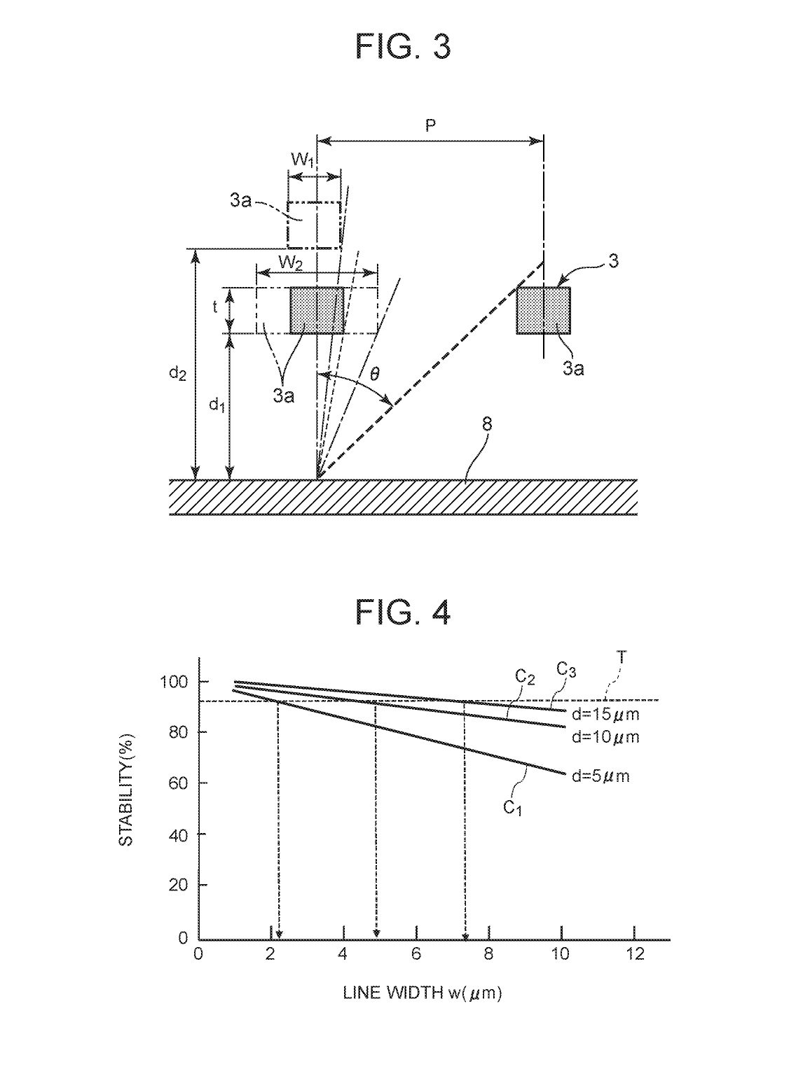

The line width of the mesh 3, which is capable of preventing the mesh 3 from becoming the shadow of deposition is determined in the following manner from a relationship with a clearance between the mesh 3 and the substrate. The determination as to the line width of the mesh 3 will be described below in detail with reference to FIGS. 3 and 4.

FIG. 3 is a typical view for describing the influence of the shadow of the mesh 3 with respect to the deposition, and FIG. 4 is a graph illustrating one example of a numerical calculation result for determining the line width of the mesh 3.

In FIG. 3, broken lines respectively indicate the incident direction of, e.g., sputter particles incident to the substrate 8. In the same drawing, the thick broken line indicates the orbit of sputter particles incident at a small angle relative to a surface of the substrate 8, and the thin broken line indicates the orbit of sputter particles incident at a large angle relative to the surface of the substrate 8. Incidentally, FIG. 3 is illustrated while paying attention only to the sputter particles incident to the substrate 8 from a right diagonally upward direction.

The sputter particles incident to the surface of the substrate 8 at the large angle are intercepted by mesh lines 3a as illustrated in FIG. 3, so that the sputter particles deposited just beneath the mesh lines 3a are reduced. That is, each mesh line 3a becomes the shadow of deposition and hence a film thickness just beneath the mesh line 3a becomes thinner than that of the other portion.

The influence of the shadow of each mesh line 3a relative to the deposition depends on the size of a clearance d between the mesh line 3a and the substrate 8, and a line width w of the mesh line 3a. That is, when the clearance d between the mesh line 3a and the substrate 8 is increased (d₁<d₂) as indicated by a thick two-dot chain line in FIG. 3, the sputter particles intercepted by the mesh line 3a are reduced so that the influence of the shadow of the mesh line 3a becomes small. On the other hand, when the line width w of the mesh line 3a is made wide (w₁<w₂) as indicated by a thin two-dot chain line in FIG. 3, the sputter particles intercepted by the mesh line 3a are increased so that the influence of the shadow of the mesh line 3a becomes large. Thus, in order to suppress the influence of the shadow of the mesh line 3a and form a thin film pattern having a uniform film thickness, the line width w of the mesh line 3a and the clearance d between the mesh line 3a and the substrate 8 must be determined appropriately.

Further, the pitch P of the mesh lines 3a also influences the deposition. As illustrated in FIG. 3, the sputter particles incident at the small angle relative to a surface of the substrate 8 are intercepted by the adjacent mesh line 3a. Thus, the pitch P of the mesh lines 3a is determined based on the maximum incident angle (tilt angle to the normal line of the substrate 8) 0 of the sputter particles. That is, in order to suppress the influence of each adjacent mesh line 3a for the deposition, the pitch P of the mesh lines 3a must be determined assuming that the thickness of the mesh 3 is t:

P≦(d+t)×tan θ+w/2

FIG. 4 illustrates a relationship between the line width w of the mesh line 3a and the influence (stability) of the shadow of the mesh line 3a with the clearance d between the mesh line 3a and the substrate 8 being taken as a parameter. In the same drawing, a line C₁ is given when the clearance d is 5 μm, a line C₂ is given when the clearance d is 10 μm, and a line C₃ is given when the clearance d is 15 μm. Further, the stability of 100% indicates a state when the line width w of the mesh 3 is zero, i.e., the mesh 3 is not present. In order to form the thin film pattern having the uniform film thickness, the stability is desirably greater than or equal to 90% with 90% as a threshold T. That is, the allowable value of a film thickness distribution is within 10%.

According to FIG. 4, in order to suppress the influence of the shadow of each mesh line 3a relative to the deposition and provide film deposition with a uniform film thickness, it is desirable that the line width w of the mesh line 3a is determined to be about 2 μm being a value corresponding to an intersection point between the line C₁ and the threshold T when the clearance d is 5 μm, for example. It is also desirable that when the clearance d is 10 μm, the line width w of the mesh line 3a is determined to be about 5 μm being a value corresponding to an intersection point between the line C₂ and the threshold T. Further, it is desirable that when the clearance d is 15 μm, the line width w of the mesh line 3a is determined to be about 7 μm being a value corresponding to an intersection point between the line C₃ and the threshold T.

The above has described the example of determining the line width w of the mesh line 3a for depositing the thin film pattern having the uniform film thickness. On the other hand, in forming a transparent electrode of a touch panel, the sheet resistance of a transparent conductive film forming the transparent electrode is more important than the film thickness distribution. In general, the sheet resistance of an ITO (Indium Tin Oxide) transparent conductive film necessary for a touch panel may be 40 Ω/cm or less.

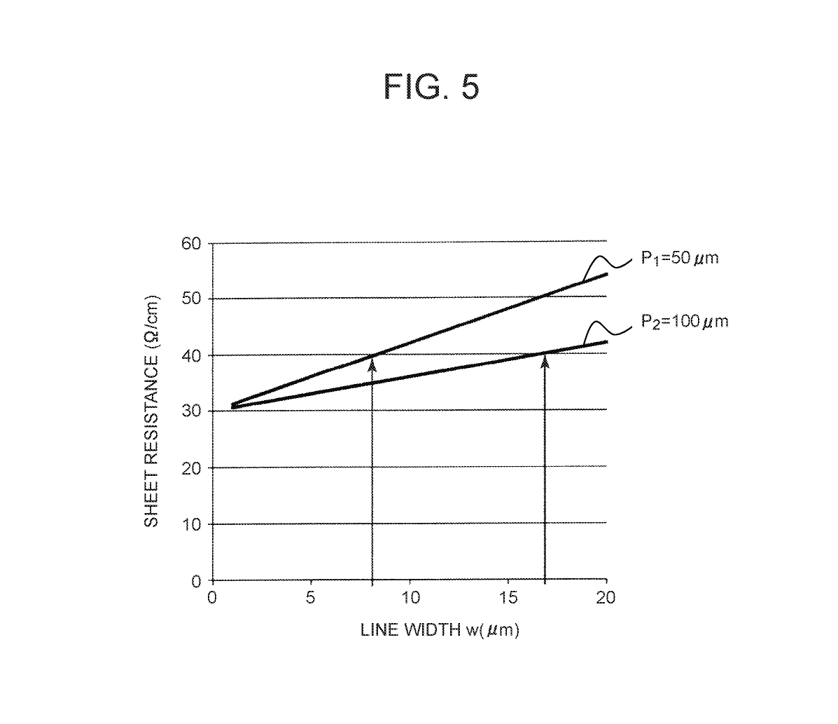

FIG. 5 is a graph illustrating, with the pitch P of the mesh lines 3a as a parameter, the dependence of an ITO sheet resistance on a mesh line width when assuming that an ITO film thickness of a portion (portion of eye 7) free of the mesh lines 3a is 200 nm and an ITO film thickness below the mesh lines 3a becomes as thin as 100 nm. According to the same drawing, as the pitch P of the mesh lines 3a becomes fine from P₂=100 μm to P₁=50 μm, portions thin in film thickness, which exist per unit length are increased, thus increasing a sheet resistance value. Further, since portions thin in film thickness are increased even when the line width w of the mesh line 3a is made wide, the sheet resistance value increases.

Determining the line width w of the mesh 3 for forming the ITO transparent conductive film by using FIG. 5 may be performed in the following manner That is, when the pitch P of the mesh lines 3a is P₁=50 μm, the line width w of the mesh line 3a may be determined to be about 8 μm or less being a value corresponding to an intersection point between a line of 40 Ω/cm being the threshold of the sheet resistance and the line P₁. Further, when the pitch P of the mesh lines 3a is P₂=100 μm, the line width w of the mesh line 3a may be determined to be about 16 μm or less being a value corresponding to an intersection point between the line of 40 Ω/cm being the threshold of the sheet resistance and the line P₂.

Since the transparent electrode of the touch panel is formed in a display panel of liquid crystal, organic EL or the like, the eyes 7 of the mesh 3 transferred onto the transparent electrode must not be visualized. Therefore, the eyes 7 of the mesh 3 should be set to a size of such a degree that they cannot be visually confirmed. The pitch P of the mesh lines 3a is approximately desirably 100 μm or less.

A frame 4 is provided in a peripheral edge region of the other surface 2c of the above shielding member 2 while being connected therewith. This frame 4 is one which supports the shielding member 2 and is a frame-like member having an aperture of such a size as to include therein a plurality of openings 5 formed in the shielding member 2. The frame 4 is formed of a magnetic metal material such as Invar or an Invar alloy, or the like.

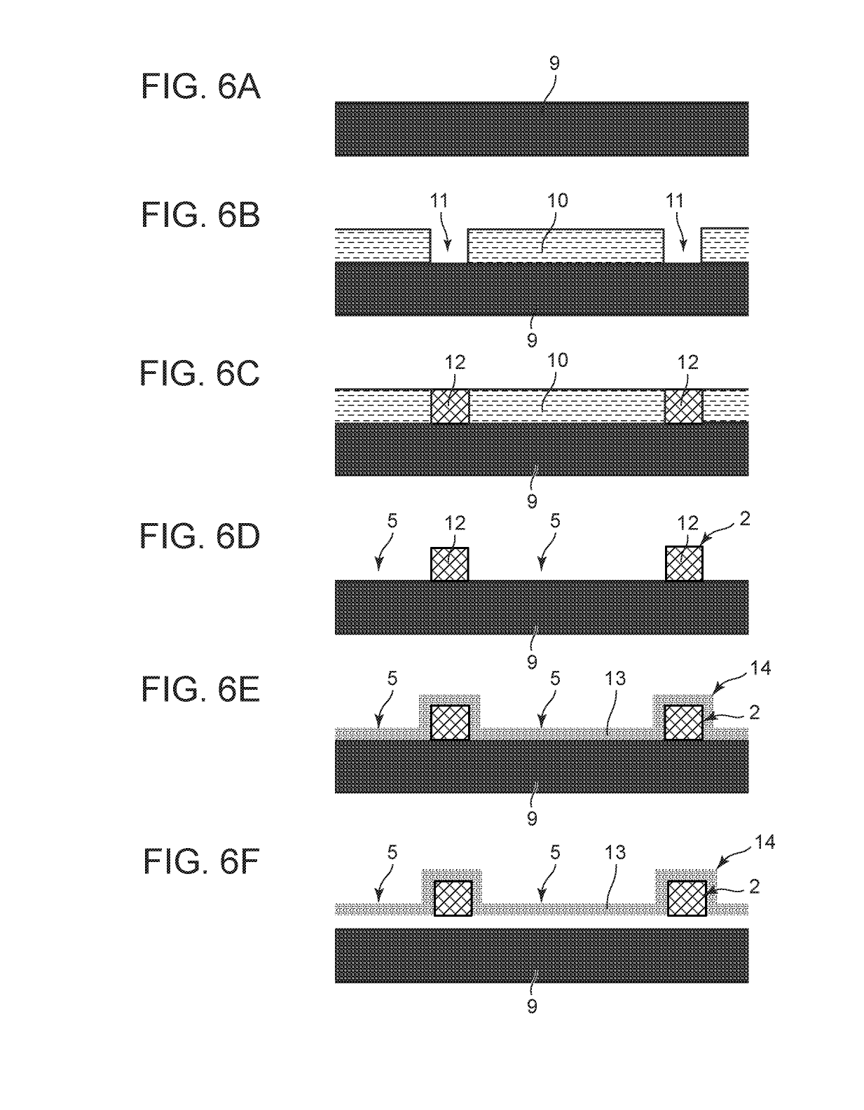

A method for producing the deposition mask 1 configured in this manner will next be described. FIG. 6 is a sectional view which describes a mask sheet forming process in the method for producing the deposition mask 1 according to the present invention. First, as illustrated in FIG. 6A, a metal plate which serves as a plated metal base material 9, e.g., a stainless plate is prepared.

Next, as illustrated in FIG. 6B, a photoresist 10 is applied on the metal base material 9 in the thickness of about 10 μm. Then, the above photoresist 10 is exposed using a photomask whose illustration is omitted and thereafter developed. Thus, the photoresist 10 corresponding to each portion which attempts to form the shielding member 2 is removed, and grooves 11 which reach the metal base material 9 are formed in the photoresist 10.

Subsequently, the metal base material 9 is immersed in, for example, a nickel plating bath and electro-plated. As illustrated in FIG. 6C, the grooves 11 of the photoresist 10 are embedded to form a magnetic thin film 12 of nickel in a thickness of about 10 μm. Thereafter, the photoresist 10 is removed by an organic solvent or a special peeling solution. Thus, as illustrated in FIG. 6D, the shielding member 2 composed of the magnetic thin film 12 of nickel, having a plurality of openings 5 is formed in a state of being adhered onto the metal base material 9.

Next, as illustrated in FIG. 6E, for example, a liquid resin of polyimide is applied onto the shielding member 2 and the metal base material 9 within the above openings 5 in, for example, a thickness ranging from about 3 μm to 5 μm. Thereafter, this is dried by being subjected to high temperature heat treatment by the known technology, and covers the shielding member 2 and the surface of the metal base material 9 within the above openings 5 to form a film layer 13 of polyimide. Thus, a mask sheet 14 with the shielding member 2 and the film layer 13 integrated with each other is formed. Thereafter, as illustrated in the same figure F, the mask sheet 14 is peeled off from the metal base material 9.

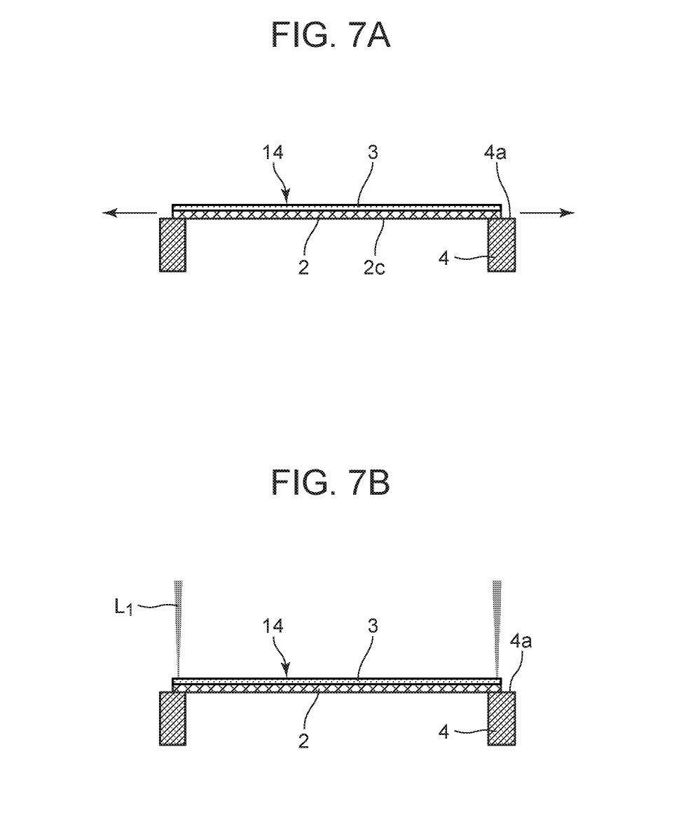

FIGS. 7A and 7B are sectional views describing a frame connecting process in the method for producing the deposition mask 1 according to the present invention. First, as illustrated in FIG. 7A, the mask sheet 14 is given a constant tension in four directions parallel to the surface of the shielding member 2 as indicated by arrows in the same figure in a state of a surface (other surface 2c of shielding member 2) being in contact with the metal base material 9 being faced to one end surface 4a of the frame-like frame 4, and is extended onto the frame 4. Next, as illustrated in FIG. 7B, a peripheral edge region of the mask sheet 14 is irradiated with laser light L₁ so that the shielding member 2 is spot-welded to the above one end surface 4a of the frame 4. Thus, the mask sheet 14 is supported by the frame 4.

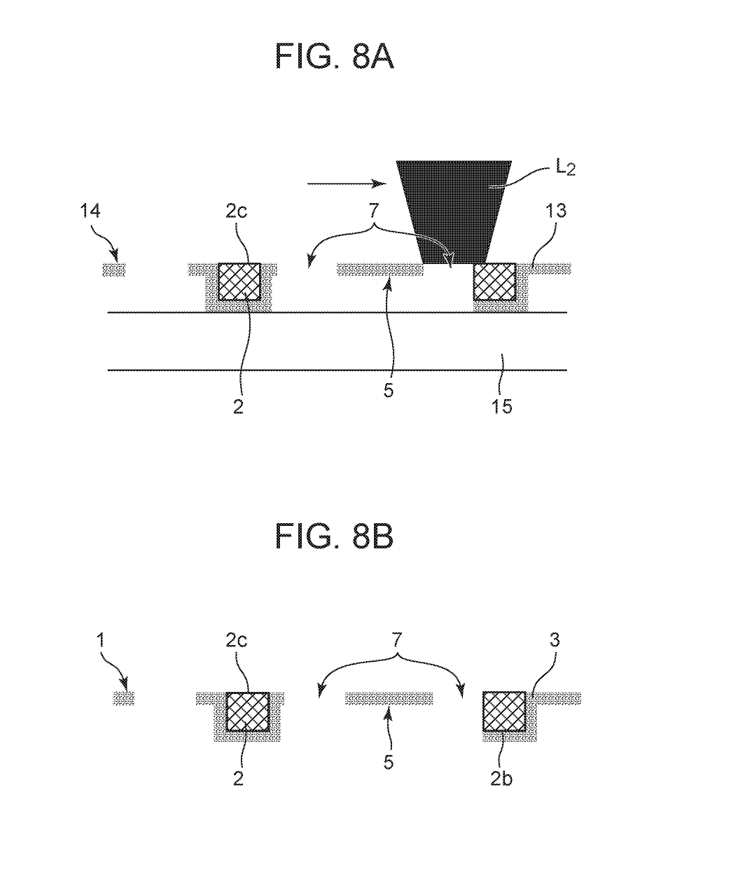

FIG. 8A and 8B are sectional views describing a mesh forming process in the method for producing the deposition mask 1 according to the present invention. The mask sheet 14 supported by the frame 4 is placed on a stage 15 of a laser processing device with the other surface 2c side of the shielding member 2 facing upside. Then, while step-moving the stage 15 and a laser optical system whose illustration is omitted, at prescribed distances determined in advance in a two-dimensional direction of XY relatively, laser light L₂ whose wavelength is 400 nm or less, which is shaped into the form of each of the eyes 7 of the mesh 3 is applied from the other surface 2c side of the shielding member 2 to within a deposition effective region (within a frame indicated by a broken line of FIG. 1A) of the mask sheet 14 including therein the plural openings 5 of the shielding member 2 as illustrated in FIG. 8A to form a mesh 3 in which eyes 7 penetrating through the film layer 13 are provided and a plurality of lattice points 6 exist within the openings 5. Thus, the deposition mask 1 is completed as illustrated in FIG. 8B.

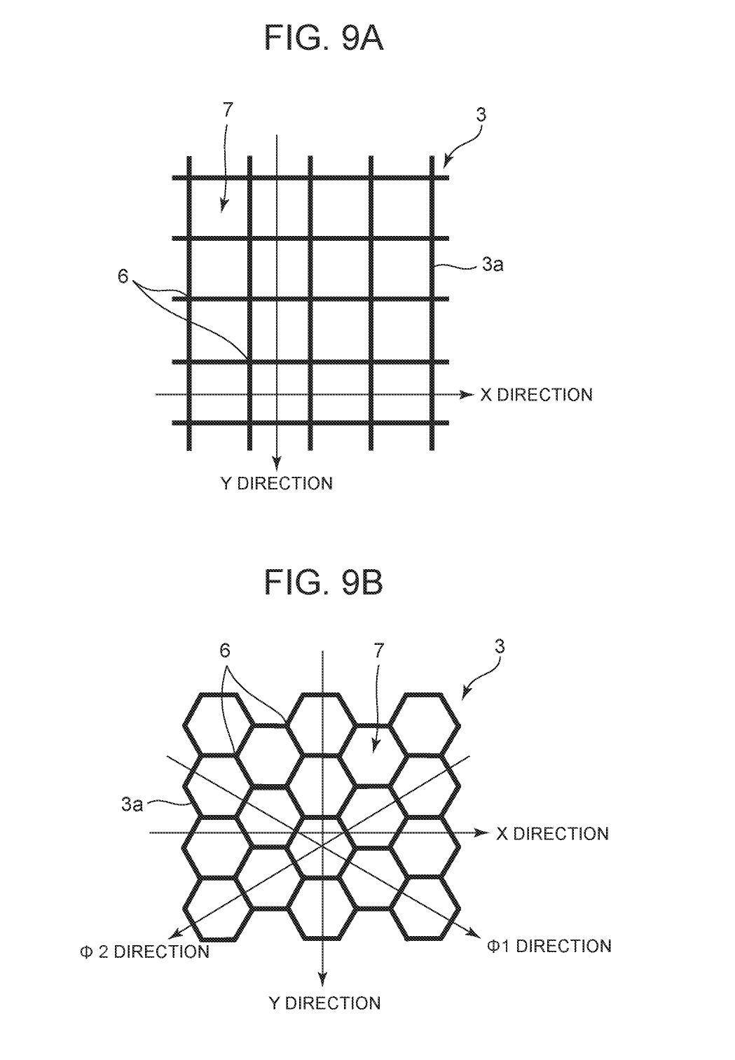

While the shape of the eyes 7 of the mesh 3 is arbitrary, for example, the shape of the eyes 7 of the mesh 3 of the deposition mask 1 for forming the transparent electrode of the touch panel is preferably an equilateral triangle, a square, a regular hexagon or the like. As illustrated in FIG. 9A, when the shape of the eyes 7 is square, for example, the eye patterns of the mesh 3 transferred onto the transparent electrode are square, and sheet resistances in the direction of X, Y become the same. It is therefore possible to make a sensor current to flow in the directions X, Y. Further, as illustrated in FIG. 9B, when the shape of the eyes 7 is regular hexagonal, for example, the eye patterns of the mesh 3 transferred onto the transparent electrode are regular hexagonal, and sheet resistances in two diagonal directions (directions φ₁, φ₂) other than the directions X, Y become substantially the same. It is therefore possible to make a sensor current to flow in four directions. Accordingly, the degree of freedom of the electrode arrangement of the touch panel is increased. Since the structure of the mesh 3 becomes strong particularly when the eye patterns are regular hexagonal, the regular hexagon is preferable.

Incidentally, although the above embodiment has described where the mask sheet 14 (shielding member 2 before forming the mesh 3) is connected to the frame 4, the present invention is not limited to it, and the shielding member 2 after having formed the mesh 3 may be connected to the frame 4. In this case, the shielding member 2 with the mesh 3 adhered thereto may be connected to the frame 4 in a state of a tension being applied thereto in four directions parallel to the surface thereof. Since a constant tension is isotropically applied to the mesh 3 in the openings 5 even though the tension is applied to the shielding member 2, there is no possibility that the openings 5 will be deformed.

Further, the frame 4 may not need to be provided. In this case, the deposition mask 1 may be arranged and deposited on the substrate 8 in a state in which a tension is applied in four directions of the deposition mask 1. Since the constant tension is isotropically applied to the mesh 3 in the openings 5 even at this time, there is no possibility that the openings 5 will be deformed.

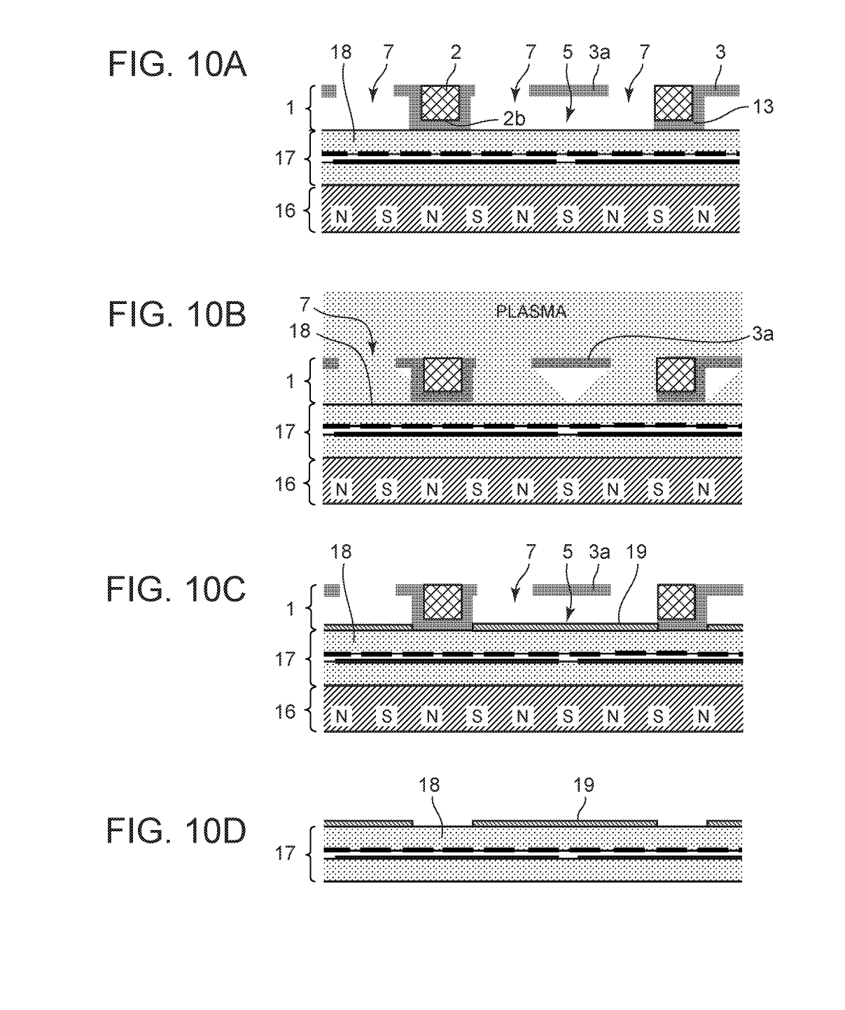

Next, the production of the touch panel, which is performed using the deposition mask 1 of the present invention will be described. FIG. 10A to 10D are sectional views describing a process of producing the touch panel. First, as illustrated in FIG. 10A, for example, a liquid crystal display panel 17 is installed on a substrate holder 16 arranged within a vacuum chamber whose illustration is omitted, of a sputtering device and having a magnet built therein, in such a manner that the transparent substrate 18 side (display surface side) becomes a target side whose illustration is omitted. Further, the deposition mask 1 is positioned and placed on the above transparent substrate 18 with the surface (one surface 2b) side formed with the film layer 13 on the shielding member 2 as the liquid crystal display panel 17 side. The positioning of the deposition mask 1 and the liquid crystal display panel 17 may be performed using openings (mask-side alignment marks) for alignment marks formed in the shielding member 2 of the deposition mask 1 simultaneously with the plating formation of the corresponding shielding member 2, and substrate-side alignment marks formed in advance in the liquid crystal display panel 17.

When the deposition mask 1 is positioned and placed on the liquid crystal display panel 17, the magnetic force of the magnet built in the substrate holder 16 is made to act on the shielding member 2 of the deposition mask 1 to attract the shielding member 2, thereby tightly adhering the deposition mask 1 onto the transparent substrate 18 of the liquid crystal display panel 17. In this case, since the deposition mask 1 is tightly adhered to the transparent substrate 18 through the resin-made film layer 13, there is no possibility of damaging the surface of the transparent substrate 18.

Next, after air in the vacuum chamber is evacuated to a prescribed degree of vacuum, for example, a rare gas as an Ar gas is introduced by a predetermined amount into the vacuum chamber. Then, as illustrated in FIG. 10B, a high voltage is applied between an ITO sputter target whose illustration is omitted, and the substrate holder 16 to generate plasma of the Ar gas, whereby sputtering is started.

Ions of the AT gas turned into the plasma collide with the ITO sputter target whose illustration is omitted, to flick sputter particles of ITO. Thus, the sputter particles are flown toward the liquid crystal display panel 17 and pass through the eyes 7 of the mesh 3 of the deposition mask 1 to be deposited on the transparent substrate 18 of the liquid crystal display panel 17. In this case, since the incident angle (tilt angle to the normal line of the transparent substrate 18) of the sputter particles incident to the transparent substrate 18 is about 70 degrees at the maximum, the sputter particles passing through the eyes 7 of the mesh 3 penetrate around into the lower side of each mesh line 3a of the mesh 3 and are deposited on the transparent substrate 18 as illustrated in FIG. 10B. Accordingly, as illustrated in FIG. 10C, a thin film of ITO is deposited on the transparent substrate 18 in correspondence to each opening 5 of the shielding member 2 of the deposition mask 1, so that a transparent electrode 19 is formed. Thus, as illustrated in FIG. 10D, the touch panel having the transparent electrode 19 on the liquid crystal display panel 17 is completed.

Incidentally, although the above embodiment has described where the mesh 3 is of the resin, the present invention is not limited to it. The mesh 3 may be a metal material or may be a magnetic metal material.

Further, although the above description has been made about the deposition by sputtering, the present invention is not limited to it. The deposition may be PVD (Physical Vapor Deposition) including evaporation, ion plating or the like, or CVD (Chemical Vapor Deposition). Also, the substrate and the film deposition source are not limited to those arranged opposed to each other. The film deposition source may be arranged in the direction diagonal to the substrate. Further, the substrate and the film deposition source may be those moved relatively.

It should be noted that the entire contents of Japanese Patent Application No. 2014-090447, filed on Apr. 24, 2014, on which convention priority is claimed, is incorporated herein by reference.

It should also be understood that many modifications and variations of the described embodiments of the invention will be apparent to one skilled in the art without departing from the spirit and scope of the present invention as claimed in the appended claims.

1. A deposition mask comprising:
a sheet-like shielding member having openings in correspondence to a thin film pattern formed on a film-deposited substrate; and
a mesh having a plurality of lattice points within the openings, and supported on side wall portions of the openings of the shielding member, so as to provide a clearance between the mesh and one surface of the shielding member.

2. The deposition mask according to claim 1, wherein at least the shielding member is a magnetic metal member.

3. The deposition mask according to claim 1, wherein the mesh is formed of a resin.

4. The deposition mask according to claim 1, wherein a resin layer is formed on one surface of the shielding member.

5. A method for producing a deposition mask, the method comprising:
plating a magnetic metal material on a metal base material to form a sheet-like shielding member having openings in correspondence to a thin film pattern formed on a film-deposited substrate,
applying a liquid resin onto the shielding member and within the openings to form a film layer thinner in thickness than the shielding member; and
irradiating the film layer with laser light from a contact surface side with the metal base material to form a mesh having a plurality of lattice points at least at film layer portions corresponding to the openings, after the shielding member and the film layer are peeled off integrally from the metal base material.

6. A method for producing a touch panel by depositing a film using a deposition mask according to claim 1 to form a transparent electrode on a transparent substrate, the method comprising:
placing the deposition mask on the transparent substrate in such a manner hat one surface side of the shielding member is brought to the side of the transparent substrate; and
depositing a film from the other surface side of the shielding member to form a transparent electrode at a portion on the transparent substrate located within the opening of the shielding member by a deposition material passing through each eye of the mesh.

7. The method for producing the touch panel according to claim 6, wherein the transparent substrate is a substrate on a display surface side of a display panel.
